(19) United States
(12) Patent Application Publication
(10) Pub. No.: US 2017/0341432 A1
(43) Pub. Date: Nov. 30, 2017

(54) PRINTING AND BURSTING DEVICE

(71) Applicant: KIOSKO CO., LTD., Taoyuan (TW)

(72) Inventors: SHIH-PING LEE, Taoyuan (TW); CHIH-CHIN TZENG, Taoyuan (TW)

(21) Appl. No.: 15/409,627

(22) Filed: Jan. 19, 2017

(30) Foreign Application Priority Data
May 26, 2016 (TW) 105207827

(51) Int. Cl. B41J 11/70

(52) U.S. Cl. CPC B41J 11/70

(57) ABSTRACT

The present invention discloses a printing and bursting device which comprises an apparatus; a printing assembly, which is disposed inside the apparatus and includes a print head and a transfer wheel, with the transfer wheel being disposed underneath the print head; a picking assembly, which is disposed inside the apparatus and is in adjacent to the printing assembly, with the picking assembly including a guiding piece and a movable wheel, and the movable wheel being disposed underneath the guiding piece and being abutted with the transfer wheel; and a cutter assembly, which is disposed inside the apparatus and is in adjacent to the picking assembly, with the cutter assembly being away from the printing assembly farther than the picking assembly.

### BACKGROUND OF THE INVENTION

### a) Field of the Invention

The present invention relates to a printing device, and more particularly to a printing and bursting device by which the release paper of gum paper is removed and then the gum paper is cut into any specified length automatically.

### b) Description of the Prior Art

The invention of the printing technology enables knowledge to be transported quickly. In recent years, due to the rapid development of the electronic technology, the printing technology has entered into a time period of electronic control and automation, followed by the popularity of the printing devices. Nowadays, the printing devices are used in offices, shopping malls, hospitals or even homes, and the documents containing texts or pictures can be printed out quickly according to the size of paper, such as delivery orders, receipts or invoices, in order to improve the speed in dealing with businesses. Therefore, the printing devices have become indispensable copying equipment.

Most of the existing printing devices can carry out the printing job for all sizes and types of paper, including the gum paper with the release paper, such as label paper. However, when an existing printing device is printing the gum paper, the paper is directly outputted after accomplishing the printing job, just like printing ordinary paper. Thus, when receiving the gum paper which is outputted after printing, a user still needs to peel off the release paper manually, and this is not very convenient in use.

### SUMMARY OF THE INVENTION

Accordingly, the object of the present invention is to provide a printing and bursting device by which the release paper of gum paper is removed and then the gum paper is cut into any specified length automatically.

In accordance with the object of the present invention, the present invention discloses a printing and bursting device which comprises an apparatus; a printing assembly, which is disposed inside the apparatus and includes a print head and a transfer wheel, with the transfer wheel being disposed underneath the print head; a picking assembly, which is disposed inside the apparatus and is in adjacent to the printing assembly, with the picking assembly including a guiding piece and a movable wheel, the movable wheel being disposed underneath the guiding piece and being abutted with the transfer wheel; and a cutter assembly, which is disposed inside the apparatus and is in adjacent to the picking assembly, with the cutter assembly being away from the printing assembly farther than the picking assembly.

Preferably, the apparatus includes a base and an upper cover which is connected on the base.

Preferably, a side of the upper cover is locked on the base; whereas, the other side of the upper cover is movably connected on the base or movably separates from the base.

Preferably, the upper cover movably escapes from the base.

Preferably, the cutter assembly includes a first blade and a second blade. The first blade is disposed on the upper cover, the second blade is disposed on the base, and the first blade can movably displace along a longitudinal direction to approach or move away from the second blade which is disposed fixedly, or the second blade can movably displace along a longitudinal direction to approach or move away from the first blade which is disposed fixedly.

Preferably, the printing and bursting device further includes a clipping assembly. The clipping assembly is disposed inside the apparatus and is in adjacent to the cutter assembly. In addition, the clipping assembly is away from the picking assembly farther than the cutter assembly. The clipping assembly includes a first clipping piece and a second clipping piece which is in adjacent to the first clipping piece.

Preferably, the printing and bursting device further includes a control module which is disposed inside the apparatus. The control module is connected with the printing assembly, the picking assembly, the cutter assembly and the clipping assembly to control the print head to carry out the printing job, to control the transfer wheel and the movable wheel to rotate, and to control the first blade or the second blade to displace longitudinally.

Preferably, the first blade and the second blade are provided respectively with a dent at a place away from the cutting edge.

Preferably, the guiding piece can be in an L-shape, as an example.

Preferably, the guiding piece can be polygonal, as an example.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a first schematic view of a printing and bursting device, according to the present invention.

FIG. 2 shows a second schematic view of the printing and bursting device, according to the present invention.

FIG. 3 shows a third schematic view of the printing and bursting device, according to the present invention.

FIG. 4 shows a fourth schematic view of the printing and bursting device, according to the present invention.

FIG. 5 shows a fifth schematic view of the printing and bursting device, according to the present invention.

FIG. 6 shows a sixth schematic view of the printing and bursting device, according to the present invention.

FIG. 7 shows a seventh schematic view of the printing and bursting device, according to the present invention.

FIG. 8 shows an eighth schematic view of the printing and bursting device, according to the present invention.

FIG. 9 shows a ninth schematic view of the printing and bursting device, according to the present invention.

### DETAILED DESCRIPTION OF THE PREFERRED EMBODIMENTS

In order to facilitate the examiner to understand the technical features, the contents and the advantages of the present invention, as well as the efficacy that can be reached by the present invention, the present invention will now be described in detail with the drawings and the form of expression of the embodiment. The drawings used are only for illustration and support of the specification, and hence are not necessarily accurate in scale and precise in configuration after implementation of the present invention. Therefore, it should not be interpreted based upon the scale and the configuration on the drawings to confine the scope of the rights claimed on the practical implementation of the present invention.

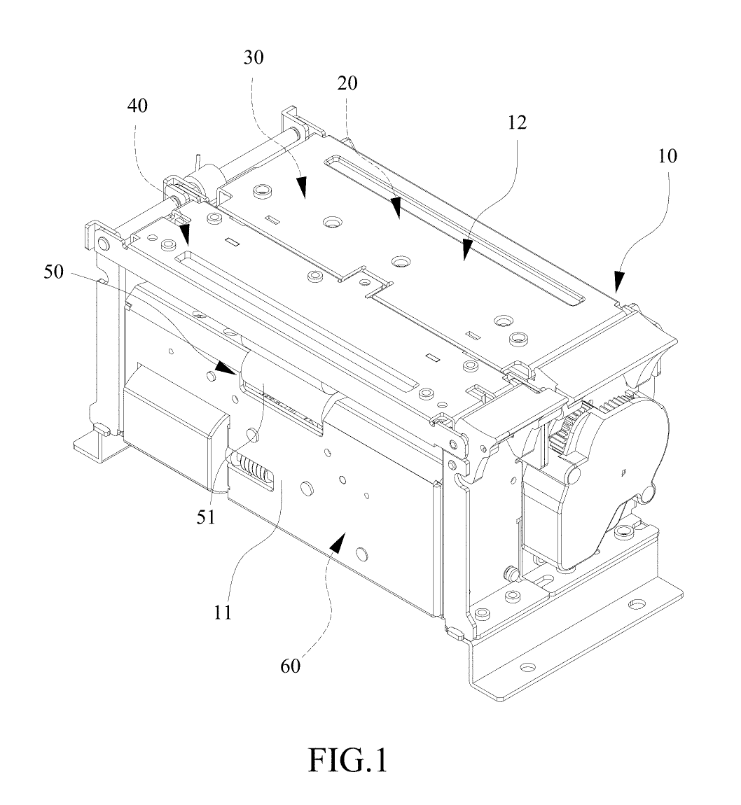

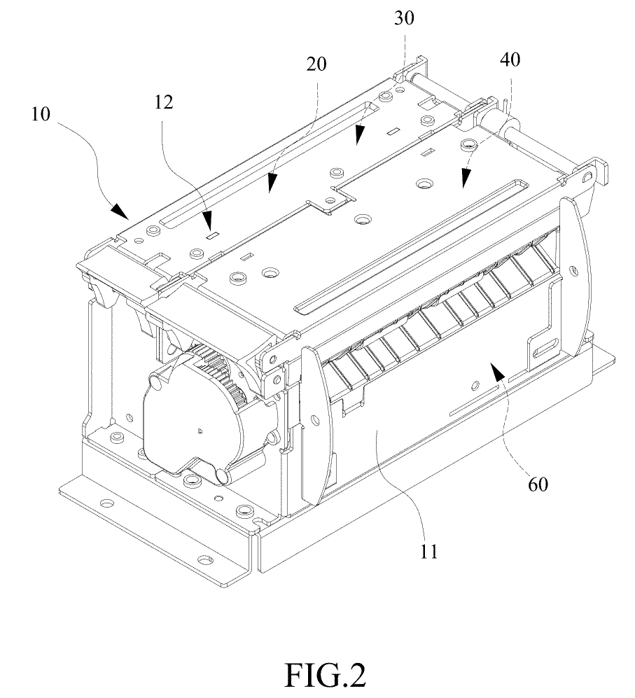

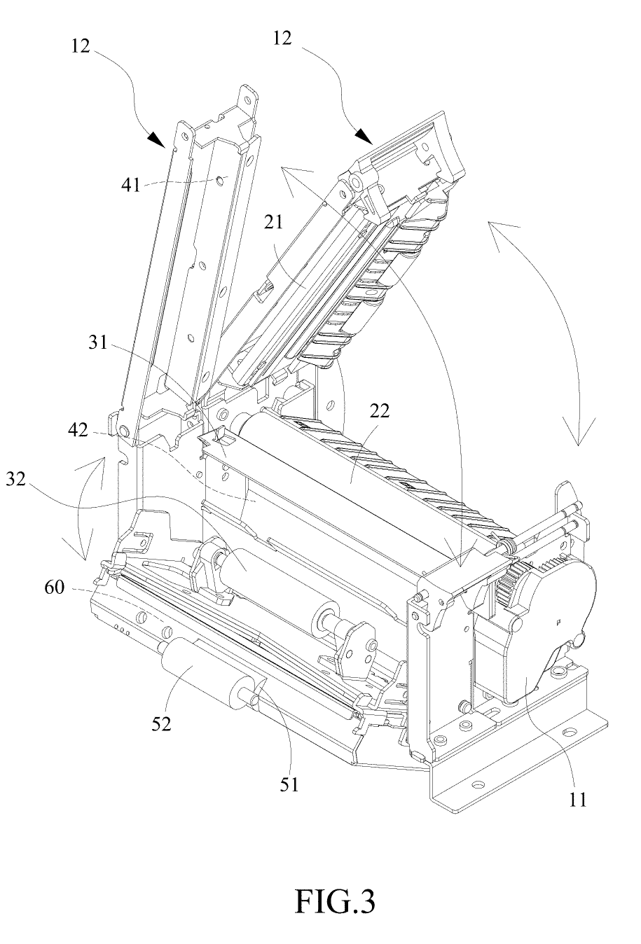

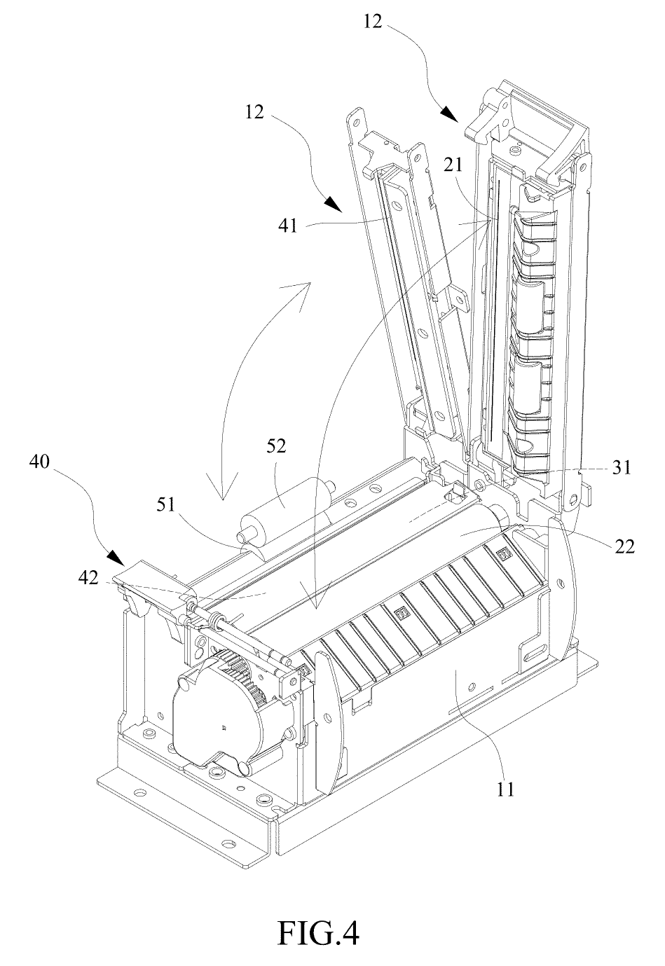

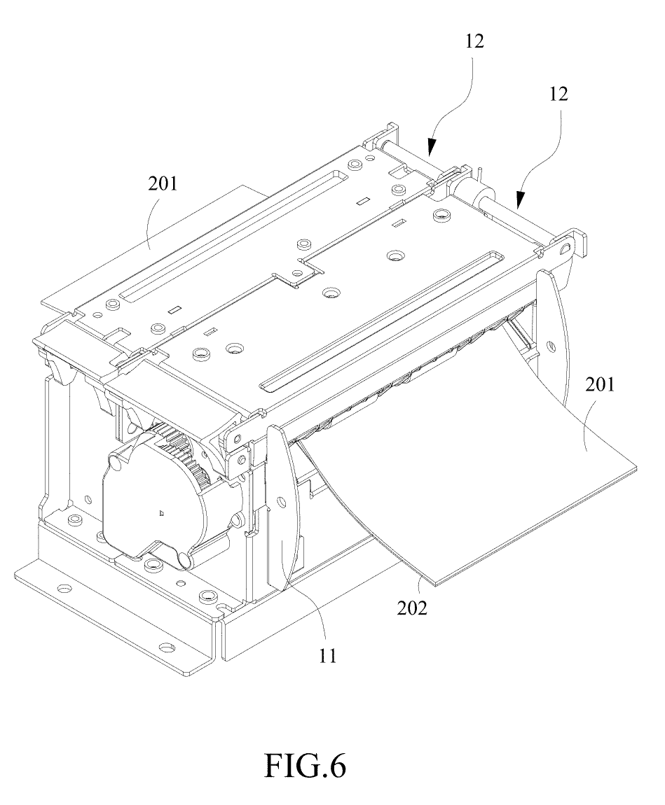

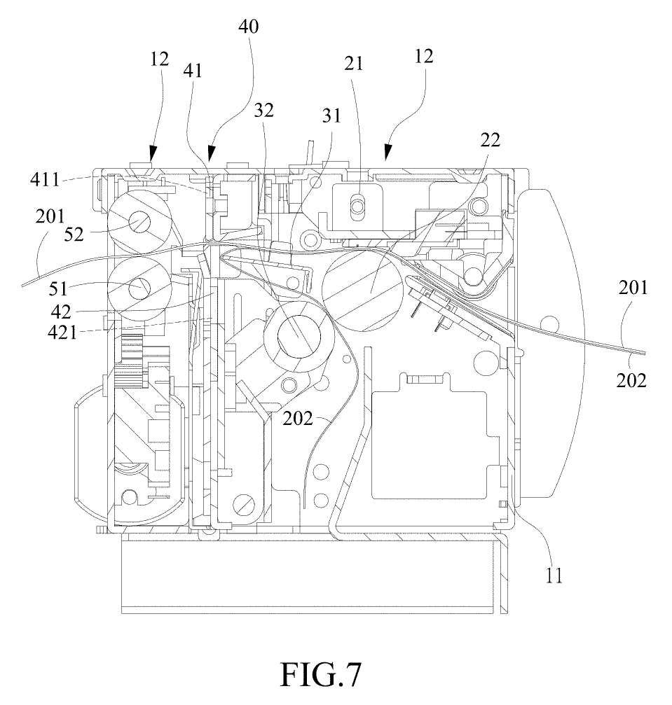

Referring to FIGS. 1 to 9, it shows a first schematic view of a printing and bursting device, a second schematic view of the printing and bursting device, a third schematic view of the printing and bursting device, a fourth schematic view of the printing and bursting device, a fifth schematic view of the printing and bursting device, a sixth schematic view of the printing and bursting device, a seventh schematic view of the printing and bursting device, an eighth schematic view of the printing and bursting device and a ninth schematic view of the printing and bursting device, according to the present invention. The printing and bursting device of the present invention is used primarily to print paper in all sizes and types, and when that device prints gum paper having the release paper, the release paper can be peeled off automatically, so as to improve the convenience in use. This printing and bursting device comprises an apparatus 10, a printing assembly 20, a picking assembly 30, a cutter assembly 40, a clipping assembly 50 and a control module 60. The printing assembly 20, the picking assembly 30, the cutter assembly 40, the clipping assembly 50 and the control module 60 are disposed inside the apparatus 10, and the control module 60 is connected with the printing assembly 20, the picking assembly 30, the cutter assembly 40, and the clipping assembly 50. The printing assembly 20 is close to a feed-in end of the apparatus 10, the picking assembly 30 is in adjacent to the printing assembly 20, the cutter assembly 40 is in adjacent to the picking assembly 30 and is away from the printing assembly 20 farther than the picking assembly 30, the clipping assembly 50 is in adjacent to the cutter assembly 40 and is away from the picking assembly 30 farther than the cutter assembly 40, and the clipping assembly 50 is close to an exit end of the apparatus 10. In short, along the path of paper printing and feeding, the components that are disposed from the feed-in end to the exit end of the apparatus 10 are the printing assembly 20, the picking assembly 30, the cutter assembly 40 and the clipping assembly 50 orderly.

Specifically, the apparatus 10 includes a base 11 and an upper cover 12. The upper cover 12 is connected on the base 11. Preferably, a side of the upper cover 12 is locked on the base 11, and the other side of the upper cover 12 is movably connected on the base 11 or movably separates from the base 11, as shown in FIGS. 1 to 4. Or, the upper cover 12 can movably and completely escape from the base 11, so that the upper cover 12 can be opened to facilitate cleaning and loading paper. The printing assembly 20 includes a print head 21 and a transfer wheel 22. The transfer wheel 22 is disposed underneath the print head 21, the print head 21 is controlled by the control module 60 to carry out the printing job, and the transfer wheel 22 is controlled by the control module 60 to rotate. The picking assembly 30 includes a guiding piece 31 and a movable wheel 32. The movable wheel 32 is disposed underneath the guiding piece 31 and abuts with the transfer wheel 22. The movable wheel 32 is controlled by the control module 60 to rotate. The guiding piece 31 can be in an L-shape or can be polygonal for an example, and is preferably in a triangular shape. The cutter assembly 40 includes a first blade 41 and a second blade 42. The first blade 41 is disposed on the upper cover 12, and the second blade 42 is disposed on the base 11. One of the first blade 41 and the second blade 42 can be designed as a movable blade, and the other one is a fixed blade. If the first blade 41 is a movable blade, then it can be controlled by the control module 60 to displace longitudinally to approach or move away from the second blade 42 that is disposed fixedly. On the other hand, if the second blade 42 is a movable blade, then it can be controlled by the control module 60 to displace longitudinally to approach or move away from the first blade 41 that is disposed fixedly. Preferably, the first blade 41 and the second blade 42 are provided respectively with a dent 411, 421 at a place away from the cutting edge.

Moreover, the clipping assembly 50 includes a first clipping piece 51 and a second clipping piece 52. Gum paper is transfixed between the first clipping piece 51 and the second clipping piece 52 to facilitate keeping stability and smoothness in delivering the gum paper. In addition, the first clipping piece 51 and the second clipping piece 52 can be transfer wheels or the first clipping piece 51 and the second clipping piece 52 can be spring leaves.

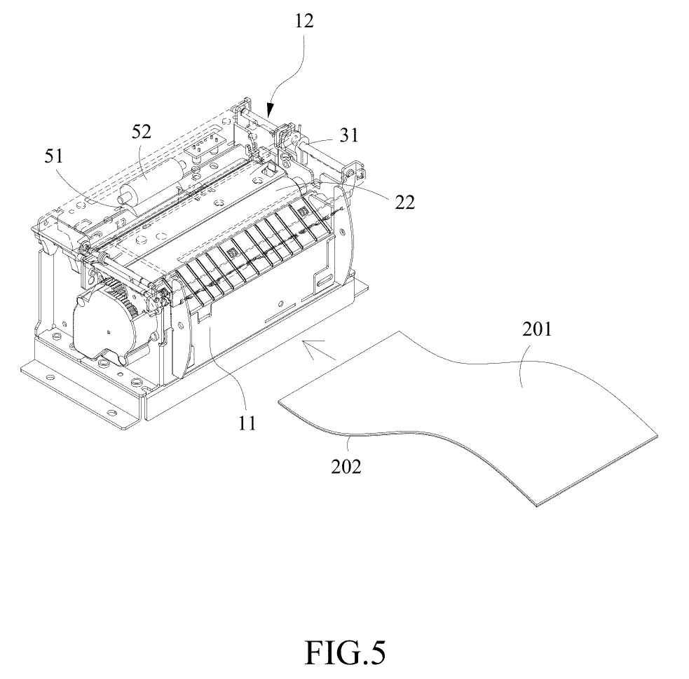

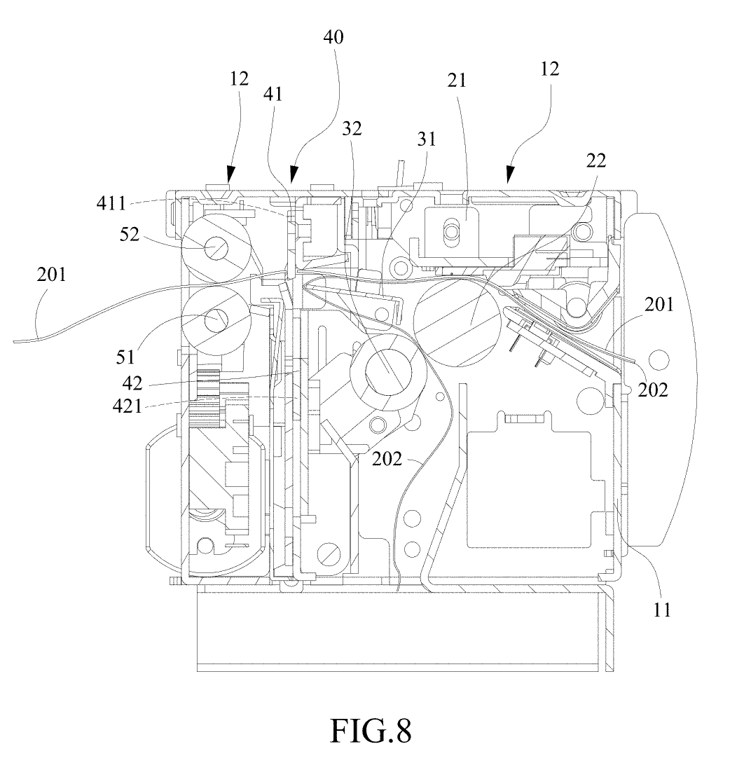

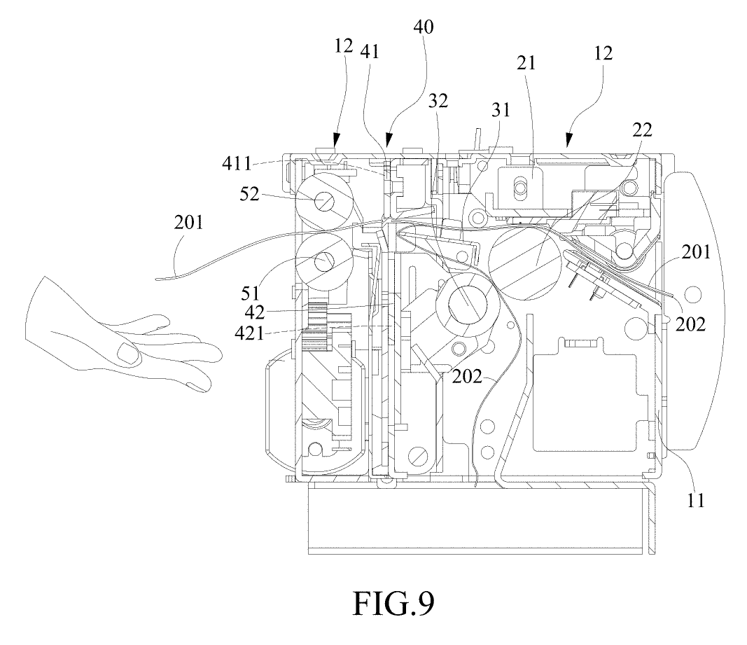

The printing and bursting device of the present invention can be used to print gum paper having the release paper and perform the bursting job to the gum paper. The bursting procedure is shown in FIGS. 5 to 9. First of all, before executing the printing job, gum paper with the release paper 202 is put into the apparatus 10, wherein the front end of main paper 201 of the gum paper needs to be protruded out of the exit end of the apparatus 10 to be clipped by the first clipping piece 51 and the second clipping piece 52, the release paper 202 at the front end part needs to be peeled off manually in advance to clip the front end of the part of the release paper 202 that is peeled off manually between the transfer wheel 22 and the movable wheel 32, and the part of the release paper 202 that is peeled off in advance should be abutted at the guiding piece 31 to manifest in a curved shape, as shown in FIGS. 5 to 7. Next, the printing and bursting device is activated, the print head 21 prints the main paper 201 of the gum paper, and the transfer wheel 22 and the clipping assembly 50 carry the gum paper to move toward the exit end of the apparatus 10. In the process of printing, the guidance of the guiding piece 31 as well as the rolling and dragging of the transfer wheel 22 and the movable wheel 32 will be utilized to peel off the release paper 202 from the main paper 201 automatically, and the main paper 201 that has done printing and with the release paper 201 peeled off can be cut off by the first blade 41 and the second blade 42, as shown in FIG. 8 and FIG. 9. As the first blade 41 and the second blade 42 are provided respectively with the dent 411, 421, the sticking of gum onto the main paper 201 can be reduced through the dent 411, 421.

Accordingly, when the printing and bursting device of the present invention prints the gum paper having the release paper, the picking assembly that is formed by the simple structures can be utilized to peel off the release paper on the gum paper and then cut the gum paper into any specified length without being limited by the fixed length of the ordinary label paper, so as to achieve the object of processing various specifications of the label at a same time when attaching the label automatically, thereby saving the cost and time in disposing the residual of gum.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A printing and bursting device comprising:
an apparatus;
a printing assembly, which is disposed inside the apparatus and includes a print head and a transfer wheel, with the transfer wheel being disposed underneath the print head;
a picking assembly, which is disposed inside the apparatus and is in adjacent to the printing assembly, with the picking assembly including a guiding piece and a movable wheel, the movable wheel being disposed underneath the guiding piece and being abutted with the transfer wheel; and
a cutter assembly, which is disposed inside the apparatus and is in adjacent to the picking assembly, with the cutter assembly being away from the printing assembly farther than the picking assembly.

2. The printing and bursting device according to claim 1, wherein the apparatus includes a base and an upper cover which is connected on the base.

3. The printing and bursting device according to claim 2, wherein a side of the upper cover is locked on the base, whereas the other side of the upper cover is movably connected with the base or movably separates from the base.

4. The printing and bursting device according to claim 2, wherein the upper cover movably escapes from the base.

5. The printing and bursting device according to claim 2, wherein the cutter assembly includes a first blade and a second blade, the first blade is disposed on the upper cover, the second blade is disposed on the base, the first blade movably displaces along a longitudinal direction to approach or move away from the second blade which is disposed fixedly, or the second blade movably displaces along a longitudinal direction to approach or move away from the first blade which is disposed fixedly.

6. The printing and bursting device according to claim 5, wherein the first blade and the second blade are provided respectively with a dent at a place away from the cutting edge.

7. The printing and bursting device according to claim 5, further comprising a clipping assembly which is disposed inside the apparatus and is in adjacent to the cutter assembly, with the clipping assembly being away from the picking assembly farther than the cutter assembly, the clipping assembly including a first clipping piece and a second clipping piece, and the first clipping piece being in adjacent to the second clipping piece.

8. The printing and bursting device according to claim 7, wherein the first clipping piece and the second clipping piece are transfer wheels, or the first clipping piece and the second clipping piece are spring leaves.

9. The printing and bursting device according to claim 7, further comprising a control module which is disposed inside the apparatus and is connected with the printing assembly, the picking assembly, the cutter assembly and the clipping assembly to control the print head to carry out the printing job, to control the transfer wheel and the movable wheel to rotate, and to control the first blade or the second blade to displace longitudinally.

10. The printing and bursting device according to claim 1, wherein the guiding piece is in an L-shape.

11. The printing and bursting device according to claim 1, wherein the guiding piece is polygonal.
